(19) United States
(12) Patent Application Publication
(10) Pub. No.: US 2012/0165452 A1
(43) Pub. Date: Jun. 28, 2012

(54) OIL-BASED INKJET INK

(75) Inventors: Kyoko MOTOYAMA, Ibaraki-ken (JP); Satoshi AOKI, Ibaraki-ken (JP)

(73) Assignee: RISO KAGAKU CORPORATION, Tokyo (JP)

(21) Appl. No.: 13/337,865

(22) Filed: Dec. 27, 2011

(30) Foreign Application Priority Data
Dec. 28, 2010 (JP) 292799/2010

(51) Int. Cl. C08K 5/101

(52) U.S. Cl. 524/317

(57) ABSTRACT

An oil-based inkjet ink contains at least a pigment, a non-aqueous resin dispersion microparticles having pigment dispersing ability and a solvent, where the solvent includes a solvent having at least an ester group and an ether group in a single molecule.

### BACKGROUND OF THE INVENTION

1. Field of the Invention

The present invention relates to an oil-based inkjet ink that is suitable for use with an inkjet recording system.

2. Description of the Related Art

Inkjet recording systems eject highly fluid inkjet inks from very thin head nozzles as ink particles to record an image on a sheet of printing paper, which is positioned to face the nozzles. In particular, use of a line head-type inkjet recording device provided with a number of ink heads allows high-speed printing, and such inkjet recording devices are rapidly becoming widely used in recent years. As an ink for use with the inkjet recording systems, various types of so-called oil-based inkjet inks, which are formed by finely dispersing a pigment in a non-water-soluble solvent, have been proposed.

For example, the applicant has proposed, in Japanese Unexamined Patent Publication No. 2007-126564, an ink formed by dispersing a pigment in a nonpolar solvent, such as an ester solvent, a higher alcohol solvent or a hydrocarbon solvent. This ink is advantageous in that it has excellent on-machine stability and it can provide a printed surface that does not adhere to another printed surface printed with a PPC duplicator or a laser printer even when they are stacked in contact with each other.

An oil-based inkjet ink is a penetrate-and-dry type ink, which does not dry and solidify itself but penetrates into a print material, such as paper, and dries. When high-speed printing is conducted, a time taken from printing to output is short, and a problem of so-called roller transfer contamination (which will hereinafter simply be referred to as “transfer contamination”) may occur, where undried ink printed on the surface of paper is transferred onto conveyance rollers and is further transferred from the rollers to the next print material conveyed thereto to contaminate the print material.

Oil-based inks typically contain a pigment dispersant, which is soluble in a solvent (which may hereinafter be referred to as “soluble dispersant”). Use of the soluble dispersant increases affinity of the solvent for the pigment, and this increases tendency of the pigment to penetrate into a print material when the solvent penetrates into the print material. This often results in low print density and strike through. As an ink to solve this problem, the applicant has proposed non-aqueous pigment inks, which employ, as the dispersant, a non-aqueous resin dispersion microparticles with pigment dispersing ability (which may hereinafter be referred to as NAD (Non Aqua Dispersion)) (Japanese Unexamined Patent Publication Nos. 2007-197500 and 2010-1452).

Use of the NAD in the inks proposed in Japanese Unexamined Patent Publication Nos. 2007-197500 and 2010-1452 keeps the pigment staying on the surface of paper, thereby increasing the print density and reducing or eliminating the strike through. However, since the pigment stays on the surface of the print material, the problem of transfer contamination cannot be eliminated. That is, the increase of print density and the reduction of transfer contamination are trade-off, and one of them has been sacrificed to a certain degree.

### SUMMARY OF THE INVENTION

The present inventors have found through intensive study that use of the NAD in combination with a specific solvent can achieve both the increase of print density and the reduction or elimination of transfer contamination, to achieve the present invention. That is, the present invention is directed to providing an oil-based inkjet ink that can achieve the increase of print density and the reduction or elimination of transfer contamination at the same time.

An aspect of the oil-based inkjet ink of the invention is an oil-based inkjet ink including at least a pigment, a non-aqueous resin dispersion microparticles having pigment dispersing ability and a solvent, wherein the solvent includes a solvent having at least an ester group and an ether group in a single molecule.

The solvent may preferably be a glycol ether ester-based solvent, and may further preferably be diethylene glycol monobutyl ether acetate.

The non-aqueous resin dispersion microparticles having pigment dispersing ability contained in the oil-based inkjet ink of the invention are formed by a resin having pigment dispersing ability, where polymer particles that do not dissolve in the solvent stably disperse to form a particle dispersion system. Therefore, it can increase the separation property between the solvent and the pigment after printing, and can prevent the pigment from penetrating into the print material along with the solvent, thereby increasing the print density. Further, when the solvent includes the solvent having at least an ester group and an ether group in a single molecule, faster separation between the solvent and the pigment is achieved. This can increase the penetration rate, thereby reducing or eliminating the transfer contamination. That is, the present invention can achieve the increase of print density and the reduction or elimination of transfer contamination at the same time by interaction between the non-aqueous resin dispersion microparticles and the solvent having at least an ester group and an ether group in a single molecule.

### DESCRIPTION OF THE PREFERRED EMBODIMENTS

An oil-based inkjet ink of the invention (which may hereinafter simply be referred to as “ink”) is an ink containing at least a pigment, a non-aqueous resin dispersion microparticles (NAD) having pigment dispersing ability and a solvent, wherein the solvent includes a solvent having at least an ester group and an ether group in a single molecule (the latter solvent may hereinafter be referred to as “specific solvent” for distinguishing it from the other solvent).

The NAD is an acryl-based polymer (urethane-modified acryl polymer) which has an alkyl (meth)acrylate unit including an alkyl group with a carbon number of 12 or more and a (meth)acrylate unit including a urethane group. The NAD does not dissolve in a non-aqueous solvent used in the ink, and forms microparticles in the ink. The “(meth)acrylate” herein refers to acrylate and methacrylate.

The NAD has a core/shell structure including a core (polar moiety) that does not dissolve in the solvent and a shell (low-polar moiety) that is oriented toward and solvates with the solvent. It is believed that the core that is insoluble in the solvent increases the separation property between the solvent and the pigment after printing, thereby preventing the pigment from penetrating into the paper along with the solvent and making the pigment stay on the surface of the paper to increase the print density, and the shell (stereo repelling layer) increases dispersion stability in the solvent to form a particle dispersion system.

The alkyl (meth)acrylate unit has the long-chain alkyl group with a carbon number of 12 or more, and therefore has excellent affinity for the solvent and increases dispersion stability in the solvent, thereby serving as the shell. The alkyl chain in the ester moiety may be linear or branched. The upper limit of the carbon number of the alkyl group is not particularly limited; however, the carbon number of the alkyl group may preferably be not more than 25 in view of availability of the material, etc.

Examples of the alkyl group with a carbon number of 12 or more may include dodecyl group, tridecyl group, tetradecyl group, pentadecyl group, hexadecyl group, heptadecyl group, octadecyl group, nonadecyl group, eicosanyl group, henicosanyl group, docosanyl group, isododecyl group, isooctadecyl group, and the like. Two or more of these alkyl groups may be included.

The (meth)acrylate unit including a urethane group includes an urethane group (urethane bond) with high polarity for adsorbing the pigment, namely, a carbamate ester (H₂NCOOR, RNHCOOR) moiety, thereby taking the pigment therein to form the core (the moiety insoluble in the solvent) of the NAD. The urethane group forms, together with the long-chain alkyl group, a side chain (branch) on the main chain (trunk) of the acryl-based polymer. The branch including the urethane group may form polyurethane having repeated urethane bonds to form a branch polymer.

The molecular weight (mass-average molecular weight) of the NAD is not particularly limited. However, when the NAD is used in an inkjet ink, the molecular weight of the NAD may preferably be in the range from about 10000 to about 100000, or more preferably be in the range from about 20000 to about 80000 in view of ejection of the ink.

The glass-transition temperature (Tg) of the NAD may preferably be not more than room temperature, or more preferably be not more than 0° C. This glass-transition temperature allows promotion of film formation at room temperature when the ink is fixed on the recording medium.

The particle size of the NAD is not particularly limited. However, when the NAD is used in an inkjet ink, the particle size of the NAD needs to be small enough relative to the nozzle diameter. Therefore, the particle size of the NAD may generally be not more than 0.3 μm, or more preferably be not more than 0.1 μm.

The NAD can preferably be produced by reacting, in a copolymer of a monomer mixture which includes the alkyl (meth)acrylate (A) including an alkyl group with a carbon number of 12 or more (which may hereinafter be referred to as “monomer (A)”) and a reactive (meth)acrylate (B) including a functional group reactive with an amino group (which may hereinafter be referred to as “monomer (B)”) (this copolymer may hereinafter be referred to as “trunk polymer”), the functional group reactive with an amino group of the monomer (B) with an aminoalcohol and a polyisocyanate compound to introduce a urethane group.

Examples of the monomer (A), in particular, the alkyl (meth)acrylate (A) including a long-chain alkyl group with a carbon number of 12-25 may include lauryl (meth)acrylate, cetyl (meth)acrylate, stearyl (meth)acrylate, behenyl (meth)acrylate, isolauryl (meth)acrylate, and isostearyl (meth)acrylate. The monomer (A) may include two or more of these monomers.

Preferred examples of the functional group reactive with an amino group of the monomer (B) may include glycidyl group, vinyl group, and (meth)acryloyl group. An example of the monomer (B) including a glycidyl group may be glycidyl (meth)acrylate. Preferred examples of the monomer (B) including a vinyl group may include vinyl (meth)acrylate, 2-(2-vinyloxy ethoxy) ethyl (meth)acrylate, etc. Examples of the monomer (B) including a (meth)acryloyl group may include dipropylene glycol di(meth)acrylate, 1,6-hexanediol di(meth)acrylate, etc. Two or more of theses reactive (meth)acrylates (B) may be included.

The monomer mixture may include, besides the monomers (A) and (B), a monomer (C) which is co-polymerizable with the monomers (A) and (B) in a range where the effect of the invention is not impaired. Examples of the monomer (C) may include styrene-based monomers, such as styrene, α-methyl styrene, etc.; vinyl ether-based polymers, such as vinyl acetate, vinyl benzoate, butyl vinyl ether, etc.; and maleate, fumarate, acrylonitril, methacrylonitril, α-olefin, etc. Further, an alkyl (meth)acrylate with an alkyl chain length of a carbon number of less than 12, such as 2-ethylhexyl (meth)acrylate, isooctyl (meth)acrylate, tert-octyl (meth)acrylate, etc., may be used. These monomers may be used singly or in combination of two or more species.

The content of the monomer (A) in the monomer mixture may preferably be 30 mass % or more, more preferably be 40 to 95 mass %, or even more preferably be 50 to 90 mass %. The content of the monomer (B) in the monomer mixture may preferably be 1 to 30 mass %, or more preferably be 3 to 25 mass %. The content of the monomer (C) other than the monomers (A) and (B) in the monomer mixture may preferably be not more than 60 mass %, or more preferably be 10 to 40 mass %.

Each of the above-described monomers can easily be polymerized by known radical copolymerization. A preferred reaction system may be solution polymerization or dispersion polymerization. In this case, use of a chain transfer agent during polymerization is effective to provide a molecular weight of the acryl-based polymer after the polymerization in the above-described preferred range. Preferred examples of the chain transfer agent may include thiols, such as n-butyl mercaptan, lauryl mercaptan, stearyl mercaptan, cyclohexyl mercaptan, etc.

As a polymerization initiator, any of known thermal polymerization initiators may be used, and examples thereof may include azo compounds, such as AIBN (azobisisobutyronitrile), peroxides, such as t-butyl peroxy benzoate, t-butyl peroxy-2-ethyl hexanoate (PERBUTYL O available from NOF Corporation), etc. As another example, a photopolymerization initiator, which generates radical when exposed to an active energy beam, may be used.

A polymerization solvent used in the solution polymerization may, for example, be a petroleum-based solvent (aroma-free (AF) type). As the polymerization solvent, one or more solvents may preferably be selected from solvents which can be used as the solvent in the ink (which will be described later). Besides the above-described agents, a polymerization inhibitor, a polymerization promoter, a dispersant, etc., which are commonly used during a polymerization reaction, may be added to the reaction system.

Subsequently, the urethane group is introduced by reacting the functional group reactive with an amino group in the resulting copolymer (trunk polymer) with the aminoalcohol and the polyisocyanate compound. The amino group of the aminoalcohol reacts with and bonds to the functional group reactive with an amino group of the monomer (B). Then, the isocyanate ester group (R¹N═C═O) of the polyisocyanate compound is added to the hydroxy group of the aminoalcohol through an addition reaction as shown below to provide the urethane group (urethane bond) (carbamate ester: R¹NHCOOR).

R¹N═C═O+R—O→ROCONHR¹

The “R—” represents the aminoalcohol moiety bound to the functional group of the trunk polymer.

In this manner, the urethane group acting as a pigment adsorbing group is introduced into the trunk polymer, which does not have the pigment adsorbing ability.

Examples of the aminoalcohol may include monomethyl ethanol amine, diethanol amine, diisopropanol amine, etc. Among them, a dialkanol amine (secondary alkanol amine) represented by the general formula:

(HOR)₂NH

(where R represents a divalent hydrocarbon group) may be preferable since the number of the urethane groups formed by providing two hydroxy groups can be increased. Two or more of these aminoalcohols may be used in combination.

Preferably 0.05 to 1 molar equivalent, or more preferably 0.1 to 1 molar equivalent of the aminoalcohol may be reacted with the functional group reactive with an amino group of the monomer (B) in view of introducing an appropriate amount of urethane groups. If the amount of the aminoalcohol is less than 1 molar equivalent, unreacted functional groups remain in the monomer (B). The unreacted functional groups are believed to act as pigment adsorbing groups.

Examples of the polyisocyanate compound may include aliphatic, alicyclic and aromatic polyisocyanate compounds, such as 1,6-diisocyanate hexane, 1,3-bis (isocyanate methyl) benzene, 1,3-bis(isocyanate methyl) cyclohexane and 1,5-naphthalene diisocyanate. Two or more polyisocyanate compounds may be used. Preferably a nearly equivalent amount (0.98 to 1.02 molar equivalent) of the polyisocyanate compound relative to the hydroxy group included in the prepared material is reacted so that no unreacted material, or the like, remain after the reaction with the hydroxy group to introduce the urethane group.

In this manner, the urethane side chain moiety (graft moiety), which is insoluble in the solvent, is formed at the aminoalcohol bound to the monomer (B) on the copolymer moiety (trunk polymer), which is soluble in the solvent, and this forms a core of the dispersion particle. Through this process, finally polymer particles (NAD) wrapped in the shell structure (trunk polymer) that are able to solvate with the solvent are formed.

The ink of the invention contains the solvent having at least an ester group and an ether group in a single molecule. Specifically, the solvent may preferably have a structure represented by general formula (1) or (2) below (where R¹ represents CH₃ or C₂H₅, R² represents H or CH₃, R³ represents a hydrocarbon with a carbon number of 1 to 4 (which may be linear or branched), m represents an integer from 1 to 4, and n represents an integer from 2 to 3):

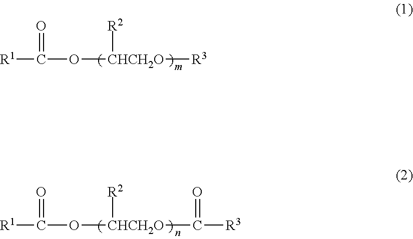

The ink of the invention containing the specific solvent has a higher polarity, and can achieve faster separation of the solvent from the ink component and a higher penetration rate. Thus, reduction or elimination of the transfer contamination is achieved.

The specific solvent may preferably be a glycol ether ester-based solvent in view of the penetration rate and the safety. Specific examples thereof may include ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, propylene glycol monoethyl ether acetate, propylene glycol monobutyl ether acetate, dipropylene glycol monomethyl ether acetate, dipropylene glycol monoethyl ether acetate, dipropylene glycol monobutyl ether acetate, and mixtures thereof. In view of the print density and the storage stability, diethylene glycol monobutyl ether acetate may be more preferable.

The entire solvent may be formed by the specific solvent. However, a hydrocarbon-based solvent described below may be combined with the specific solvent to further increase the separation property between the pigment and the solvent, thereby increasing the print density. In this view, the amount of the specific solvent may be 10 to 75 mass %, or more preferably be 10 to 30 mass % relative to the entire solvent. If the amount of the specific solvent is less than 10 mass %, separation between the pigment and the solvent is insufficient and it is difficult to increase the print density. On the other hand, If the amount of the specific solvent exceeds 75 mass %, the ejection stability may be impaired depending on the selected specific solvent.

The solvent other than the specific solvent may be selected as appropriate from nonpolar organic solvents and polar organic solvents. Preferred examples of the nonpolar organic solvent may include aliphatic hydrocarbon solvents, alicyclic hydrocarbon-based solvents, aromatic hydrocarbon solvents, etc. Preferred examples of the aliphatic hydrocarbon solvents and alicyclic hydrocarbon-based solvents may include: TECLEAN N-16, TECLEAN N-20, TECLEAN N-22, NISSEKINAPHTESOL L, NISSEKINAPHTESOL M, NISSEKINAPHTESOLH, NO. 0 SOLVENT L, NO. 0 SOLVENT M, NO. 0 SOLVENT H, NISSEKI ISOSOL 300, NISSEKI ISOSOL 400, AF-4, AF-5, AF-6 and AF-7 available from JX Nippon Oil & Energy Corporation; and ISOPAR G, ISOPAR H, ISOPAR L, ISOPAR M, EXXSOL D40, EXXSOL D80, EXXSOL D100, EXXSOL D130 and EXXSOL D140 available from Exxon. Preferred examples of the aromatic hydrocarbon solvents may include NISSEKI CLEANSOL G (alkyl benzene) available from JX Nippon Oil & Energy Corporation, SOLVESSO 200 available from Exxon, etc.

Examples of the polar organic solvent may include ester-based solvents, alcohol-based solvents, higher fatty acid-based solvents, ether-based solvents, and mixed solvents thereof. Preferred examples of the ester-based solvents may include methyl laurate, isopropyl laurate, isopropyl myristate, isopropyl palmitate, isostearyl palmitate, methyl oleate, ethyl oleate, isopropyl oleate, butyl oleate, methyl linoleate, isobutyl linoleate, ethyl linoleate, isopropyl isostearate, soybean oil methyl ester, soybean oil isobutyl ester, tall oil methyl ester, tall oil isobutyl ester, diisopropyl adipate, diisopropyl sebacate, diethyl sebacate, propylene glycol monocaprate, trimethylolpropane tri-2-ethylhexanoate, glyceryl tri-2-ethylhexanoate, etc.

Preferred examples of the alcohol-based solvents may include isomyristyl alcohol, isopalmityl alcohol, isostearyl alcohol, oleyl alcohol, etc.

Preferred examples of the higher fatty acid-based solvents may include isononanoic acid, isomyristic acid, hexadecanoic acid, isopalmitic acid, oleic acid, isostearic acid, etc.

Preferred examples of the ether-based solvents may include diethylene glycol monobutyl ether, ethylene glycol monobutyl ether, propylene glycol monobutyl ether, propylene glycol dibutyl ether, etc.

The above-listed nonpolar organic solvents and polar organic solvent may be used singly or in mixture of two or more species, as appropriate.

The pigment used in the invention may be any of organic pigments and inorganic pigments commonly known in the art of printing, and is not particularly limited. Specifically, carbon black, cadmium red, chrome yellow, cadmium yellow, chromium oxide, viridian, titanium cobalt green, ultramarine blue, prussian blue, cobalt blue, azo-based pigment, phthalocyanine-based pigment, quinacridone-based pigment, isoindolinone-based pigment, dioxazine-based pigment, threne-based pigment, perylene-based pigment, thioindigo-based pigment, quinophthalon-based pigment, metal complex pigment, etc., may preferably be used. These pigments may be used singly or in combination, as appropriate. The content of the pigment may preferably be in the range from 0.01 to 20 mass % relative to the total amount of the ink.

In addition to the solvent, dispersant and pigment described above, a dye, a surfactant and a preservative agent, for example, may be added to the ink of the invention as long as no adverse influence is exerted on the penetration and drying property, the ejection stability and the storage stability of the ink.

The ink of the invention can be prepared, for example, by putting all the components at once or in fractions in a known dispersing device, such as a bead mill, to disperse the components, and filtering them with a known filtering device, such as a membrane filter, as desired.

Examples of the oil-based inkjet ink of the invention are described below.

### EXAMPLES

### Preparation of NAD 1

In a four-necked flask, 58 g of lauryl methacrylate (available from NOF Corporation), 14 g of dimethyl aminoethyl methacrylate (available from Wako Pure Chemical Industries, Ltd.), 14 g of glycidyl methacrylate (available from NOF Corporation), 42 g of 2-ethyl hexyl methacrylate (available from Wako Pure Chemical Industries, Ltd.), and 7 g of styrene macromer (available from TOAGOSEI Co., Ltd.) were mixed. Then, as a polymerization initiator, 1 g of V601 (available from Wako Pure Chemical Industries, Ltd.), 270 g of ININ (available from the Nisshin OilliO Group, Ltd.), 80 g of AF6 (AF SOLVENT NO. 6 available from JX Nippon Oil & Energy Corporation), 80 g of FOC 180 (FINE OXOCOL 180 available from Nissan Chemical Industries, Ltd.) were added, and the reaction was conducted for six hours under reflux at 80° C. to provide a solution of NAD 1.

### Preparation of NAD 2

A solution of NAD 2 was provided in the same manner as the preparation of NAD 1, except that lauryl methacrylate was replaced with stearyl methacrylate (available from Wako Pure Chemical Industries, Ltd.)

### Preparation of NAD 3

A solution of NAD 3 was provided in the same manner as the preparation of NAD 1, except that the whole amount of lauryl methacrylate was replaced with 2-ethyl hexyl methacrylate, and the whole amount of solvent was replaced with diethylene glycol monobutyl ether acetate (available from Wako Pure Chemical Industries, Ltd.)

The NAD 1 to NAD 3 had a mass-average molecular weight in the range from about 8000 to about 25000 (GPC, polystyrene equivalent).

### Preparation of Ink

Materials according to each composition shown in Table 1 below (the numerical values shown in Table 1 are in parts by mass) were premixed, and then were dispersed with a rocking mill (available from Seiwa Giken Co., Ltd.) for four hours to prepare ink samples of Examples and Comparative Examples.

### Evaluation

### Print Density

Each resulting ink sample was charged in ORPHIS-X9050 (available from Riso Kagaku Corporation), and a solid image was printed on plane paper (ASKUL MULTIPAPER SUPER SELECT SMOOTH available from ASKUL Corporation). 24 hours after the printing, OD values on the surface of the solid image and the rear side of the solid image were measured with using an optical densitometer (RD920, available from Macbeth) and were evaluated according to the following criteria.
OD on the surface
   Excellent: 1.15 or more,
   Good: 1.10 to 1.14,
   Acceptable: 1.05 to 1.09,
   Bad: 1.04 or less.
OD on the rear side
   Good: 0.20 or less,
   Acceptable: 0.21 to 0.24,
   Bad: 0.25 or more.

### Evaluation of Transfer Contamination

Each ink sample was charged in ORPHIS-X9050 (available from Riso Kagaku Corporation) and a solid image equivalent to 300 dpi was printed on the both sides of plane paper (ASKUL MULTIPAPER SUPER SELECT SMOOTH available from ASKUL Corporation). Then, the degree of contamination on non-printed areas of the printed material was visually checked and evaluated according to the following criteria.

Good: no contamination was observed visually,

Acceptable: slight transfer contamination was observed,

Bad: noticeable transfer contamination was observed.

TABLE 1

| | | | | | | | | | | Comp. | Comp. | Comp. | Comp. | Comp. |
|---|---|---|---|---|---|---|---|---|---|---|---|---|---|---|
| | | Exam- | Exam- | Exam- | Exam- | Exam- | Exam- | Exam- | Exam- | Exam- | Exam- | Exam- | Exam- | Exam- |
| | | ple 1 | ple 2 | ple 3 | ple 4 | ple 5 | ple 6 | ple 7 | ple 8 | ple 1 | ple 2 | ple 3 | ple 4 | ple 5 |
| Pig- | Carbon black | 10 | 10 | 10 | 10 | 10 | 10 | 10 | 10 | 10 | 10 | 10 | 10 | 10 |
| ment | | | | | | | | | | | | | | |
| Disper- | NAD 1 | 15 | 15 | 15 | 15 | 13.5 | | | 15 | | 15 | 13.5 | | |
| sant | NAD 2 | | | | | | 15 | | | | | | 15 | |
| | NAD 3 | | | | | | | 15 | | | | | | |
| | SOLSPERSE | | | | | 1.5 | | | | 8 | | 1.5 | | 8 |
| | 28000 | | | | | | | | | | | | | |
| Sol- | Diethylene | 20 | 30 | 15 | | | 20 | 75 | 75 | 20 | | | | |
| vent | glycol | | | | | | | | | | | | | |
| | monobutyl | | | | | | | | | | | | | |
| | ether | | | | | | | | | | | | | |
| | acetate | | | | | | | | | | | | | |
| | Triethylene | | | | 15 | 10 | | | | | | | | |
| | glycol | | | | | | | | | | | | | |
| | diacetate | | | | | | | | | | | | | |
| | Methyl oleate | 23 | 27 | 23 | 23 | 47 | 23 | | | 27 | 40 | 57 | 23 | 37 |
| | AF SOLVENT | 24 | 10 | 29 | 29 | 10 | 24 | | | 27 | 27 | 10 | 24 | 37 |
| | NO. 6 | | | | | | | | | | | | | |
| | FINEOXOCOL | 8 | 8 | 8 | 8 | 8 | 8 | | | 8 | 8 | 8 | 8 | 8 |
| | 180 | | | | | | | | | | | | | |
| | Diethylene | | | | | | | | | | | | 20 | |
| | glycol | | | | | | | | | | | | | |
| | monoethyl | | | | | | | | | | | | | |
| | hexyl ether | | | | | | | | | | | | | |
| Total | | 100 | 100 | 100 | 100 | 100 | 100 | 100 | 100 | 100 | 100 | 100 | 100 | 100 |
| Ratio of specific | | 27 | 40 | 20 | 20 | 13 | 27 | 100 | 100 | — | — | — | — | — |
| solvent to total | | | | | | | | | | | | | | |
| solvent (%) | | | | | | | | | | | | | | |
| Evalua- | Print density | Excel- | Excel- | Excel- | Good | Good | Excel- | Good | Good | Accept- | Excel- | Good | Accept- | Bad |
| tion | OD on surface | lent | lent | lent | | | lent | | | able | lent | | able | |
| | Print density | Good | Good | Good | Good | Good | Good | Good | Good | Accept- | Good | Good | Good | Accept- |
| | OD on rear | | | | | | | | | able | | | | able |
| | side | | | | | | | | | | | | | |
| | Transfer | Good | Good | Good | Good | Good | Good | Good | Good | Good | Bad | Accept- | Good | Good |
| | contamination | | | | | | | | | | | able | | |

As shown in Table 1, the ink samples of the invention, which contain the NAD and the specific solvent (diethylene glycol monobutyl ether acetate, triethylene glycol diacetate), were able to increase the print density and to reduce or eliminate the strike through and the transfer contamination at the same time. The NAD 1 to NAD 3 had different polarities. Namely, the NAD 2 had a lower polarity than that of the NAD 1, and the NAD 3 had a higher polarity than that of the NAD 1. However, as can be seen, both the increase of print density and the reduction or elimination of the transfer contamination were achieved with the NADs having different polarities. It should be noted that, although both the increase of print density and the reduction or elimination of the transfer contamination were achieved with the ink samples of Examples 7 and 8, where the entire solvent was formed by the specific solvent, it can be seen that use of a hydrocarbon-based solvent (AF SOLVENT NO. 6) in combination provided an even higher separation property between the pigment and the solvent, and thus provided an even higher print density.

The ink sample of Comparative Example 1, which contained the specific solvent but did not contain the NAD, did not cause the transfer contamination; however, it resulted in a low print density and occurrence of the strike through. The ink samples of Comparative Examples 2 and 3, which contained a solvent including an ester group and the NAD, increased the print density; however, they caused the transfer contamination. The ink sample of Comparative Example 4, which contained in the solvent a solvent including an ether group (diethylene glycol monoethyl hexyl ether) and a solvent including an ester group (methyl oleate) (i.e., the ester group and the ether group were not included in a single molecule), resulted in a lower print density than those provided by the ink samples of the invention. The mechanism of action is not exactly clear. However, it is believed that a solvent including only one of the ether group and the ester group in a single molecule has a smaller polarity difference from the polarities of the NAD and the other solvent than that of the specific solvent including the ester group and the ether group in a single molecule, and thus results in a smaller separation property between the pigment and the solvent and, in turn, a lower print density.

As described above, the ink of the invention has an increased separation property between the solvent and the pigment after printing, which is provided through the action of the NAD and the specific solvent, thereby preventing the pigment from penetrating into the print material along with the solvent and increasing the print density. Further, by achieving faster separation between the solvent and the pigment and, the penetration rate can be increased, thereby reducing or eliminating the transfer contamination.

It should be noted that, although carbon black was used as the pigment in the Examples of the present invention, it is estimated from the actions of the NAD and the specific solvent that the same effect is provided when other pigments are used.

What is claimed is:

1. An oil-based inkjet ink comprising at least a pigment, a non-aqueous resin dispersion microparticles having pigment dispersing ability and a solvent,
wherein the solvent comprises a solvent having at least an ester group and an ether group in a single molecule.

2. The oil-based inkjet ink as claimed in claim 1, wherein the solvent comprises a glycol ether ester-based solvent.

3. The oil-based inkjet ink as claimed in claim 2, wherein the solvent comprises diethylene glycol monobutyl ether acetate.
